(19) United States
(12) Patent Application Publication
(10) Pub. No.: US 2026/0253754 A1
(43) Pub. Date: Aug. 27, 2026

(54) INTERNAL FLOW STRUCTURES FOR MOLTEN SALT REACTORS

(71) Applicant: Natura Resources LLC, Abilene, TX (US)

(72) Inventor: Derek Haas, Abilene, TX (US)

(21) Appl. No.: 19/544,760

(22) Filed: Feb. 19, 2026

Related U.S. Application Data
(60) Provisional application No. 63/763,620, filed on Feb. 26, 2025.

(51) Int. Cl. G21C 1/32; G21C 3/54; G21C 15/12; G21C 17/10

(52) U.S. Cl. CPC G21C 1/322; G21C 3/54; G21C 15/12; G21C 17/10

(57) ABSTRACT

An integral molten salt reactor includes a reactor vessel, a reactor core, a heat exchanger and a channelizing assembly. The reactor vessel includes a fuel salt. The reactor core may be arranged with the reactor vessel and includes a moderator structure. The heat exchanger assembly may be arranged within the reactor vessel and configured to receive an elevated-temperature flow of the fuel salt from the reactor core along a reactor hot leg, and to output a reduced-temperature flow of the fuel salt therefrom along a reactor cold leg. The channelizing may be assembly arranged within the reactor vessel and includes a plurality of channelizing structures cooperating to nest the moderator structure within the channelizing assembly and define one or more dedicated channels between with the reactor core and the heat exchanger assembly that fluidically separates the reactor hot leg and the reactor cold from one another.

### CROSS REFERENCE TO RELATED APPLICATIONS

This application relates and claims priority to U.S. Provisional Application No. 63/763,620, filed Feb. 26, 2025, and entitled “INTERNAL FLOW STRUCTURES FOR MOLTEN SALT REACTORS,” which is hereby incorporated by reference in its entirety.

### TECHNICAL FIELD

The described examples relate generally to systems, devices, and techniques that facilitate fluid flow in nuclear reactors, including certain integral-type molten salt reactors.

### BACKGROUND

Molten salt reactors (MSRs) offer an approach to nuclear power that can utilize molten salts as their fuel in place of the conventional solid fuels used in light water reactors. Advantages include efficient fuel utilization and enhanced safety (due in part to replacing water as a coolant with molten salt). In some implementations, the functional components of the MSR (e.g., reactor core, heat exchanger and/or other functional components) may be arranged fully within an integral enclosure in order to form an integral or “pool-type” reactor whereby the fuel salt circulates between a reactor core and heat exchangers arranged with a common vessel. While such integral reactors may reduce the possibility for leaks and/or other failure mechanisms, such conventional integral reactors may require excessive volumes of molten salts, including fuel salts, to bathe or immerse the reactor core and/or other functional components in the salt. An excessive or large volume of fuel salt (e.g., such as a larger volume than may otherwise be implemented for comparable loop-type molten salt reactor designs) may increase the cost and/or complexity of the system. As such, there remains a need to reduce or optimize the volume of molten salts used in an integral reactor, while still benefiting from the efficiencies and safety improvements of an integral reactor design.

### SUMMARY

In one example, an integral molten salt reactor is disclosed. The integral molten salt reactor includes a reactor vessel with a fuel salt therein. The integral molten salt reactor further includes a reactor core arranged with the reactor vessel and includes a moderator structure. The reactor core is configured to support fission reactions in the fuel salt using the moderator structure. The reactor core is further configured to cause a heating of the fuel salt through said fission reactions. The integral molten salt reactor further includes a heat exchanger assembly arranged within the reactor vessel. The heat exchanger assembly is configured to receive an elevated-temperature flow of the fuel salt from the reactor core along a reactor hot leg. The heat exchanger assembly is further configured to output a reduced-temperature flow of the fuel salt therefrom along a reactor cold leg. The integral molten salt reactor further includes a channelizing assembly arranged within the reactor vessel. The channelizing assembly includes a plurality of channelizing structures cooperating to nest the moderator structure within the channelizing assembly. The channelizing assembly defines one or more dedicated channels between with the reactor core and the heat exchanger assembly that fluidically separates the reactor hot leg and the reactor cold from one another.

In another example, the plurality of channelizing structures may define a displacement volume configured to minimize a volume of the fuel salt required for operation of the integral molten salt reactor.

In another example, at least one channelizing structure of the plurality of channelizing structures may include a hollow metal shell defining a void space therein.

In another example, the void space may be filled and pressurized with an inert gas.

In another example, the integral molten salt reactor may further include a monitoring system integrated with reactor vessel. The monitoring system may be configured to detect a level of the inert gas within the fuel salt. The monitoring system may be further configured to deliver an indication that the level exceeds a threshold associated with a leak of the inert gas from the pressurized void space of the hollow metal shell.

In another example, the monitoring system may be further configured to determine one or more parameters indicative of a corrosivity of the integral molten salt reactor based in part on the indication of the leak.

In another example, the one or more dedicated channels may define a hot leg passage that is a sole fluid path of the reactor hot leg between the reactor core and the heat exchanger assembly.

In another example, the hot leg passage may divert the elevated-temperature fuel salt between heat exchangers of the heat exchanger assembly disposed in upper corners of the reactor vessel.

In another example, the one or more dedicated channels may further define cold leg passages that collectively form a sole fluid path of the reactor cold leg between the heat exchanger assembly and the reactor core.

In another example, the cold leg passages may route the reactor cold leg about a periphery of the reactor vessel and concentric about the reactor core.

In another example, the one or more dedicated channels may further define a cold leg passage that combines the reduced-temperature fuel salt of all of the cold leg passages. The cold leg may be the sole fluid path of the reactor cold leg into the reactor core.

In another example, a method of operating an integral molten salt reactor is disclosed. The method includes operating a reactor core, within a reactor vessel, to support fission reactions in a fuel salt using a moderator structure and thereby cause a heating of the fuel salt through said fission reactions. The method further includes receiving, at a heat exchanger assembly arranged within the reactor vessel, an elevated-temperature flow of the fuel salt from the reactor core along a reactor hot leg. The method further includes outputting, by the heat exchanger, a reduced-temperature flow of the fuel salt along a reactor cold leg. The method further includes channelizing, using a channelizing assembly that nests the moderator structure therein, and that fluidically separates the reactor hot leg and the reactor cold leg from one another, the elevated-temperature flow of the fuel salt to establish a sole fluid path of the reactor hot leg between the reactor core and the heat exchanger assembly. The method further includes channelizing the reduced-temperature flow of the fuel salt to establish a sole fluid path of the reactor cold leg between the heat exchanger assembly and the reactor core.

In another example, the channelizing may further include, using the channelizing assembly, to establish the sole fluid path of the reactor hot leg as along a longitudinal centerline of the reactor vessel. Further, the channelizing may include establishing the sole fluid path of the reactor cold leg as collectively, peripherally about the longitudinal centerline of the reactor vessel.

In another example, the channelizing assembly may include a plurality of channelizing structures including at least one channelizing structure. The at least one channelizing structure may include a hollow metal shell defining a void space therein. In this regard, the method may further include maintaining a pressurized inert gas within the void space.

In another example, the reactor vessel may be integrated with a monitoring system. In this regard, the method may further include, using the monitoring system, detecting a level of the inert gas within the fuel salt. The method may further include delivering an indication that the level exceeds a threshold associated with a leak of the inert gas from the pressurized void space of the hollow metal shell.

In another example, the method may further include, using the monitoring system, determining one or more parameters indicative of a corrosivity of the integral molten salt reactor based in part on the indication of the leak.

In another example, an integral molten salt reactor is disclosed. The integral molten salt reactor may include a reactor vessel including a fuel salt. The integral molten salt reactor may include a reactor core arranged with the reactor vessel and including a moderator structure. The reactor core is configured to support fission reactions in the fuel salt using the moderator structure. The reactor core is further configured to cause a heating of the fuel salt through said fission reactions. The integral molten salt reactor further includes a heat exchanger assembly arranged within the reactor vessel. The heat exchanger assembly is configured to receive an elevated-temperature flow of the fuel salt from the reactor core along a reactor hot leg. The heat exchanger assembly is further configured to output a reduced-temperature flow of the fuel salt therefrom along a reactor cold leg. The integral molten salt reactor further includes a channelizing assembly arranged within the reactor vessel. The integral molten salt reactor further includes a plurality of channelizing structures cooperating to nest the moderator structure within the channeling assembly. The plurality of channelizing structures establishes a sole fluid path of the reactor hot leg as along a longitudinal centerline of the reactor vessel. The plurality of channelizing structures establishes a sole fluid path of the reactor cold leg as collectively peripherally about the longitudinal centerline of the reactor vessel.

In another example, the plurality of channelizing structures may define a displacement volume configured to minimize a volume of the fuel salt required for operation of the integral molten salt reactor.

In another example, at least one channelizing structure of the plurality of channelizing structures may include a hollow metal shell defining a void space therein.

In another example, the void space may be filled and pressurized with an inert gas.

In addition to the example aspects described above, further aspects and examples will become apparent by reference to the drawings and by study of the following description.

### BRIEF DESCRIPTION OF THE DRAWINGS

FIG. 1 depicts a cross-sectional schematic representation of an example integral molten salt reactor including a channelizing assembly of the present disclosure.

FIG. 2 depicts a drain tank section of the example integral molten salt reactor of FIG. 1.

FIG. 3 depicts a reactor section of the example integral molten salt reactor of FIG. 1.

FIG. 4 depicts a heat exchange section of the example integral molten salt reactor of FIG. 1.

FIG. 5A depicts the channelizing assembly of FIG. 1.

FIG. 5B depicts flow paths of the channelizing assembly of FIG. 5A.

FIG. 6 depicts a cutaway view of the channelizing assembly of FIG. 1 including an inert gas therein.

FIG. 7A depicts a cross-sectional view of the channelizing assembly of FIG. 1 exhibiting a leak of inert gas into a molten fuel salt.

FIG. 7B depicts detail 7B of FIG. 7A.

FIG. 8 depicts the example integral molten salt reactor of FIG. 1 in a first configuration.

FIG. 9 depicts the example integral molten salt reactor of FIG. 1 in a second configuration.

FIG. 10 depicts the example integral molten salt reactor of FIG. 1 in a third configuration.

FIG. 11 depicts a flow diagram of a method of operating an internal molten salt reactor.

FIG. 12 depicts a functional block diagram of a computing system.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The description that follows includes sample systems, methods, and apparatuses that embody various embodiments of the present invention. However, it should be understood that the described invention may be practiced in a variety of forms in addition to those described herein.

The following disclosure relates generally to flow and volume optimization structures for implementation in an integral or “pool-type” molten salt reactor (MSR), such as a molten salt reactor of the present disclosure. An “integral” MSR may generally refer to a MSR in which the components of the reactor functionally associated with the reactor may be disposed inside a common enclosure or vessel with the reactor core. An integral MSR may reduce or eliminate leaks and/or other failure mechanisms by fully enclosing the functional components (e.g., the heat exchanger, the reactor core, the pump (if used), and so on) within a common, integrally constructed vessel. For example, integral MSRs may house a reactor core and one or more heat exchangers in a common vessel and cause a fuel salt to circulate within the common vessel between the reactor core (at which the fuel salt may undergo a fission reaction that heats the salt) and a heat exchanger (at which the heat is removed from the fuel salt). The molten salt nuclear reactors of the present application may utilize a form of natural convection resulting from the buoyancy of a volume of fluid contained therein, which is at a higher temperature than the surrounding fluid. Nuclear reactors using natural convection can remove the need for mechanical pumps that require maintenance and that can fail unexpectedly; however, in some cases, an integral reactor may use a pump to aid circulation. Integral or pool-type reactors may exhibit several benefits over loop-type molten salt reactors, including the containment of some or all of the functional components of the reactor within a common vessel or enclosure. Notwithstanding, the inclusion of such components within the common vessel may require an excessive, or relatively larger (e.g., larger than with reference to comparable loop-type reactors) amounts of molten salts to operate the system and to generate thermal energy therefrom. Excessive or greater amounts of molten salts may increase the cost and complexity of the system, for example, by requiring additional material containment and handling equipment and procedures, and by requiring the purchase or other procurement of said salts. As such, there remains a need to reduce or optimize the volume of molten salts used in an integral reactor, while still benefiting from the efficiencies and safety improvements inherent in an integral reactor design.

To mitigate these and other challenges, the integral MSR of the present disclosure includes a channelizing assembly. The channelizing assembly may broadly include any type of flow or volume optimization structures for implementation in an integral or “pool-type” MSR. For example, the channelizing assembly of the present disclosure may operate to fill a certain displacement volume within the reactor vessel. The displacement volume may represent a reduction in the volume of molten salt that is required to operate the integral reactor. The channelizing assembly may also include or define any of a variety of channels, routes, or other passages through which the molten salts of the system may flow during operation between the reactor core (including a moderator structure), heat exchanger and/or other functional components of system. In this regard, the volume of molten salts required for operation of the integral reactor may be reduced by a function of the displacement volume of the channelizing assembly, and the channelizing assembly itself may function to direct the molten salt of the system to the functional components to support the efficient operation of the system. By reducing the volume of molten salts used in the integral MSR, the complexity and cost associated with the system may be reduced. For example, a lesser amount of molten salt usage may reduce or simplify the containment requirements of the system, as well as reduce the procurement burden for obtaining said salts.

In one example, the channelizing assembly may include a plurality of channelizing structures arranged within the reactor vessel. The channelizing structures may be formed from a metal material, including certain stainless or other corrosion-resistant metal materials. The channelizing structures may be substantially hollow and filled with an inert gas therein. The channelizing structures may, collectively, define a displacement volume. The displacement volume may be or correspond to a volume of molten salt that is not required for the integral MSR, for example, because said volume of the reactor vessel is taken up by the channelizing structures. The channelizing structures of the present disclosure may be configured to accommodate the particular components of an integral MSR. For example, the channelizing structures may be shaped and dimensioned in order to nest the moderator structure of the reactor core therein. Further, the channelizing structures may cooperate to define one or more dedicated channels between the reactor core and a heat exchanger assembly of the system. In this regard, the channelizing structures may define fluidically separate “hot leg” and “cold leg” channels in the reactor enclosure, among other configurations.

In operation, the fluidic separation of the hot leg and the cold leg by the channelizing structures may function to define separate channels for an elevated-temperature flow of the molten fuel salt and for a reduced-temperature flow of the molten fuel salt. For example, the reactor core of the integral molten salt reactor may operate to cause a heating of a fuel salt through fission reactions. By way of particular example, the reactor core of the present disclosure may include a moderator structure (e.g., a graphite or like-structure moderator material) that supports fission reactions in the core by, among other things, moderating the rate at which said fission reactions occur. Accordingly, the fuel salt may exit the reactor core as an elevated-temperature flow of the fuel. The channelizing structures may operate to channel or direct said elevated-temperature flow of the fuel salt from the reactor core and to the heat exchanger assembly along a dedicated hot leg defined by one or more channelizing structures. Further, the heat exchanger may, in turn, operate to receive said elevated-temperature flow of the fuel salt and to output a reduced-temperature flow of the fuel salt, for example, by exchanging heat with another medium, including another molten or “coolant” salt material. The channelizing structures may operate to channel or direct said reduced-temperature flow of the fuel salt from the heat exchanger assembly and back to the reactor core along a dedicated cold leg defined by one or more channelizing structures. Accordingly, the hot leg and cold leg may be fluidically separated from one another by the one or more channelizing structures. Such separation may promote natural convection and/or efficiency thermal management within the system, for example, by optimizing the quantity of heat transferred out of the system at the heat exchanger system as opposed to being subject to thermal loss in other segments of the system, among other benefits, as described herein.

In some examples, the channelizing assembly may also function to support corrosion monitoring within the integral molten salt reactor. To illustrate, and as described herein, one or more of the channelizing structures of the channelizing assembly may form from a hollow metal shell defining a void space therein. The hollow metal shell may be formed from the same material as other components of the integral MSR, such as from the same stainless steel material as the reactor vessel enclosure. As such, the corrosive state of the hollow metal shell can be used to determine information associated with the corrosive state of such other metal components, including that of the reactor vessel. In order to determine the corrosive state of the hollow metal shell, in one example, the hollow metal shell may be filled with an inert gas. Over time, the hollow metal shell may deteriorate and corrode to the point of leaking some or all of the inert gas of the hollow metal shell into the reactor vessel and into a composition of the fuel salt therein. In this regard, a monitoring system may be integrated with the system in order to detect the presence of the inert gas within the fuel salt. The monitoring system may further be configured to deliver an indication that the presence or level of inert gas exceeds a threshold, and to determine one or more parameters indicative of corrosivity based on said level, among other functions. In this regard, the channelizing assembly may function to support corrosion monitoring, in addition to the volume and flow optimization functions described herein.

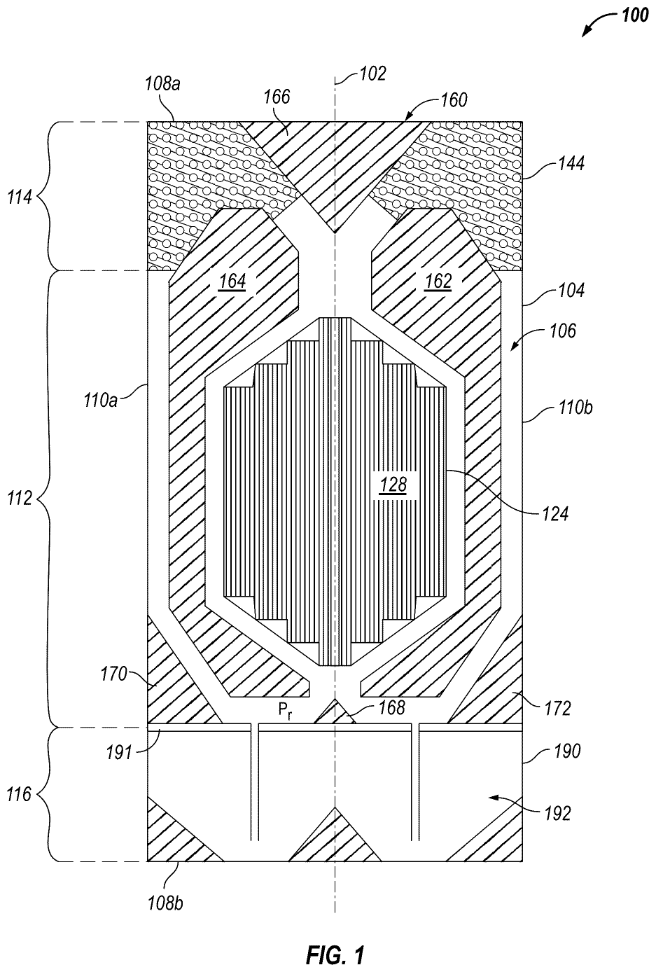

FIG. 1 depicts a schematic, cross-sectional representation of an example integral molten salt reactor or “MSR” 100, including a channelizing assembly 160 of the present disclosure. The integral MSR 100 may include functional components to establish a pool-type molten salt reactor system in which fission reactions are caused in a fuel salt to heat said salt and to extract heat therefrom. In this regard, U.S. application Ser. No. 18/449,445, filed Aug. 14, 2023, and entitled “MOLTEN SALT REACTOR CONTAINMENT” is incorporated by reference herein. As shown in the example of FIG. 1, the integral MSR includes a reactor vessel 104 having a vessel volume 106. The reactor vessel 104 may be a containment pressure vessel that houses the functional components of the integral MSR 100 therein. In this regard, the reactor vessel 104 may be constructed from a stainless steel or other metal material configured to withstand molten salt service, including withstanding temperatures in excess of 600° or 700° C. The reactor vessel 104 may be a substantially cylindrical vessel revolved about a longitudinal axis 102. For example, the reactor vessel 104 may include vessel ends 108a, 108b that may be opposite, opposing ends (or end caps, such a semi-spherical caps). The reactor vessel 104 may further include vessel sides 110a, 110b that may be portions of a continuous cylindrical surface revolved about the longitudinal axis 102 and connecting the respective first and second vessel ends 108a, 108b.

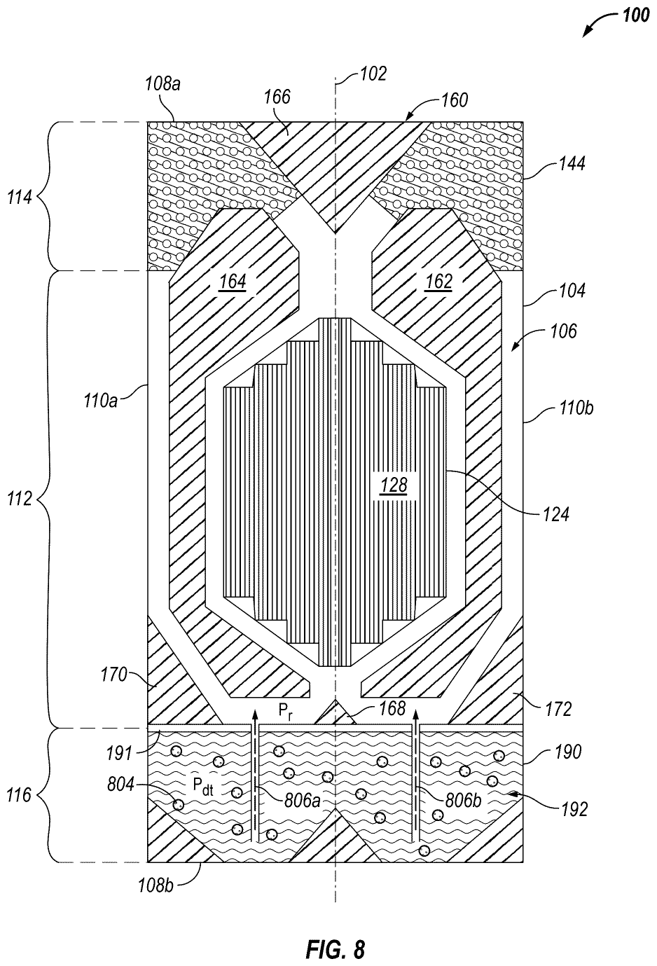

The reactor vessel 104 may broadly include various sections to support the operation of the integral MSR including a reactor section 112, a heat exchange section 114, and a drain tank section 116. Broadly, the integral MSR 100 may include a reactor core 124 arranged within the reactor section 112 of the reactor vessel 104. The reactor core 124 may include a moderator structure 128 (e.g., as formed from a graphite or other like moderator material). The reactor core 124 may be configured to support fission reactions in a fuel salt using the moderator structure 128, and to cause a heating of the fuel salt through said fission reactions. Further, the integral MSR 100 may include a heat exchanger assembly 144 arranged within the heat exchange section 114 of the reactor vessel 104. The heat exchanger assembly 144, as described herein, may be configured to receive an elevated-temperature flow of the fuel salt from the reactor core 124 along a reactor hot leg, and to output a reduced-temperature flow of the fuel salt therefrom along a reactor cold leg. As described in greater detail herein, the fuel salt of the reactor cold leg is recirculated to the reactor core 124 for subsequent fission reactions and heating of the fuel salt for establishment of a continuous cycle of heating (via fission) and heat extraction (via the heat exchanger assembly 144). As further shown in FIG. 1, the integral MSR 100 may include a drain tank 190 arranged within the drain tank section 116 of the reactor vessel 104, and further shown bounded from the reactor section 112 by a structural barrier 191. The drain tank 190 may include a tank volume 192 whereat the fuel salt the circulates between the reactor section 112 and the heat exchanger section 114 may flush and drain to during a shutdown operation, as described in greater detail herein in relation to FIG. 8-10. For example, during an operational state of the integral MSR 100, said fuel salt may circulate between the reactor section 112 and the heat exchanger section 114 for heating and heat extraction, as described above. To facilitate the foregoing, in such operational state, a pressure Pᵣ of the reactor section 112 may be generally less than a pressure P_{dt} of the drain tank section 116. During a shutdown state (emergency or non-emergency) of the integral MSR 100, the fuel salt may be caused to drain into the tank volume 192 of the drain tank 190, for example, as induced by a change of pressure whereby the pressure Pᵣ of the reactor of the reactor section 112 may be generally greater than the pressure P_{dt} of the drain tank section 116. In this regard, the drain tank 190 may operate to keep the fuel salt away from the reactor core 124 during a shutdown state in order to slow and stop fission reactions from occurring therein.

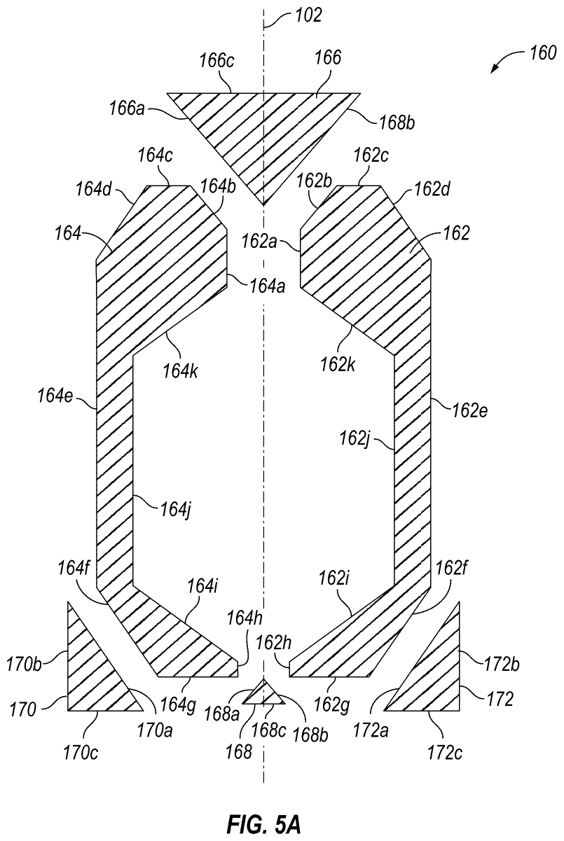

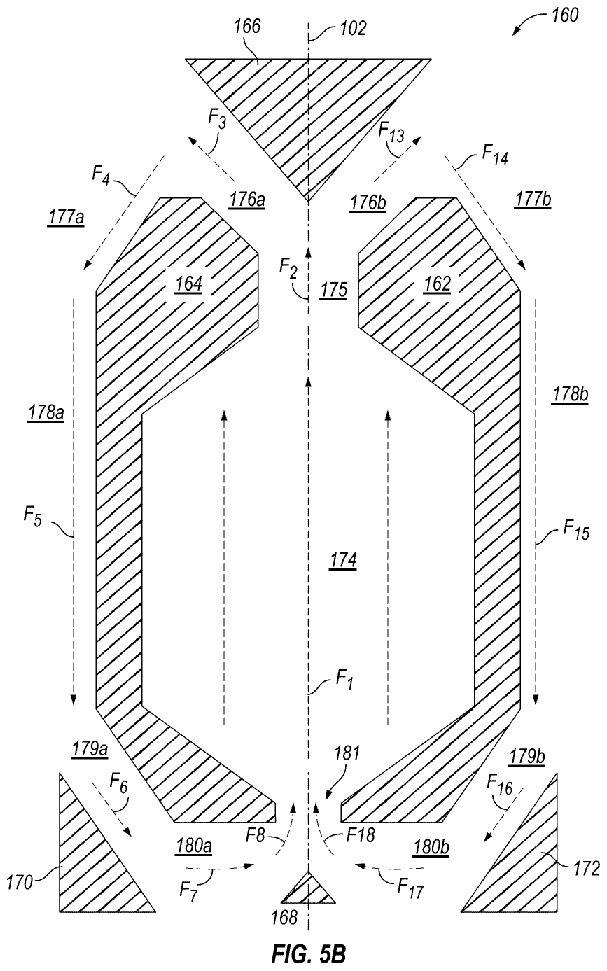

The integral MSR 100 is further shown in FIG. 1 with the channelizing assembly 160. The channelizing assembly 160, as described in greater detail herein with respect to FIGS. 5A and 5B, may include any of a variety of flow optimization structure or “channelizing structures” that cooperate to displace a volume of the fuel salt of the system and channelize fuel salt therein. For example, the channelizing assembly 160 may include, among other channelizing structures, inner insert pieces 162, 164, hot leg diverter 166, cold leg flow guides 170, 172, and cold leg combinator insert 168. The channelizing structures (e.g., the inner insert pieces 162, 164, hot leg diverter 166, cold leg flow guides 170, 172, and cold leg combinator insert 168) may collectively cooperate to nest the moderator structure 128, and to define one or more dedicated channels between the reactor core 124 and the heat exchanger assembly 144. In this regard, the integral MSR 100 may require less fuel salt, by volume, than would otherwise be required absent the volume displacement provided by the channelizing assembly 160. Further, the integral MSR 100 may operate to route fuel salt in a thermodynamically efficient manner in the elevated-and reduced-temperature states between the reactor core 124 and the heat exchanger assembly 128 without excess thermal losses throughout the system 100.

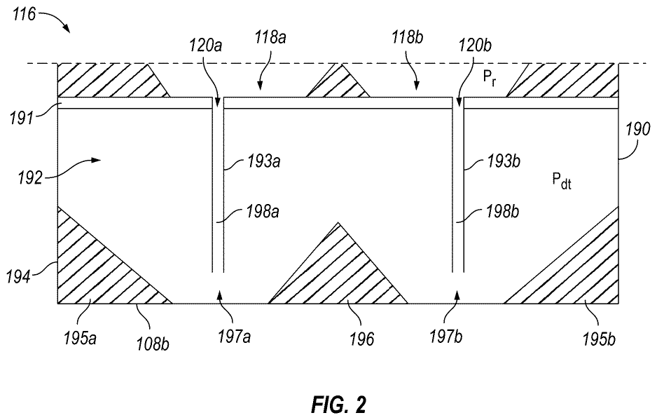

With reference to FIG. 2, the drain tank section 116 is described in greater detail below. For example, the drain tank section 116 is shown as housing the drain tank 190 as described above. The drain tank 190 is separated from the reactor section 112 by the structural barrier 191. The structural barrier 191 may generally prevent a fuel salt from passing into the drain tank 190 and tank volume 192, expect through the defined transfer pipes 193a, 193b. The transfer pipes 192a, 193b may each define respective pipe passages 198a, 198b that fluidically connect the tank volume 192 and the volume of the reactor section 112. For example, the first pipe passage 198a may extend between a first mouth 120a (that collects fluid from a channelized drain entrance 118a) to a first drain channelized region 197a of the tank volume 192. Further, the second pipe passage 198a may extend between a second mouth 120b (that collects fluid from a channelized drain entrance 118b) to a second drain channelized region 197b of the tank volume 192. The dual pipe passages established by the transfer pipes 192a, 192b may operate to support more efficient transfer of fuel salt between in and from the tank volume 192 (e.g., based on a pressure differential between P_{dt} and Pᵣ).

FIG. 2 further shows the drain tank inserts 194. The drain tank inserts 194 may form or otherwise be components of the channelizing assembly 160. For example, the drain tank inserts 194 may be channelizing structures of the channelizing assembly 160. As shown in FIG. 2, the drain tank inserts 194 may include outer drain tank inserts 195a, 195b and inner drain tank insert 196. The outer drain tank insert 195a and the inner drain tank insert 166 may cooperate to define the first drain channelized region 197a. The first drain channelized region 197a may pool fuel salt held therein for efficient collection by the transfer pipe 193a for transfer of the fuel salt into and out of the drain tank 190. Further, the outer drain tank insert 195b and the inner drain tank insert 166 may cooperate to define the second drain channelized region 197b. The second drain channelized region 197b may pool fuel salt held therein for efficient collection by the transfer pipe 193b for transfer of the fuel salt into and out of the drain tank 190.

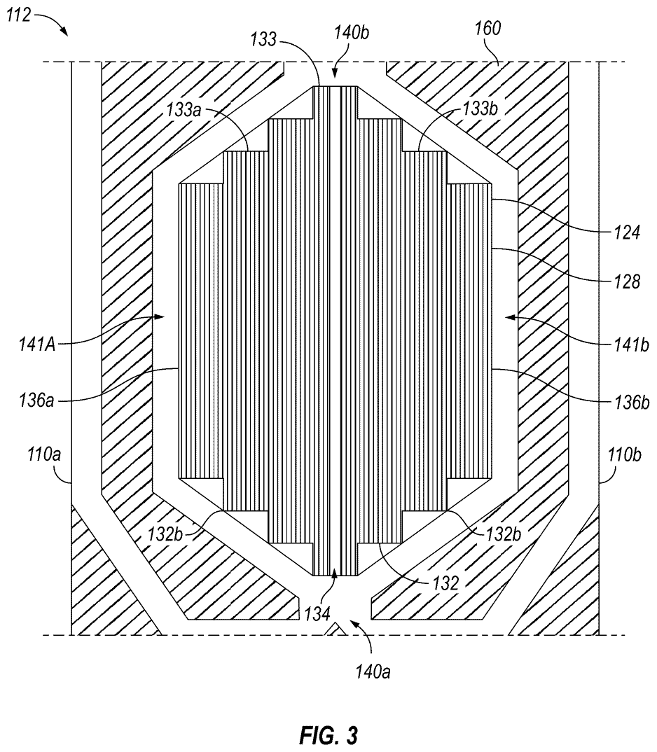

With reference to FIG. 3, the reactor section 112 is described in greater detail below. The reactor section 112 is shown as including the reactor core 124 and the moderator structure 128 described herein. The moderator structure 128 may be formed from a variety of moderating materials, including certain graphite materials, that are configured to collectively control one or more parameters of fission reactions that occur within the reactor section 112. As shown in FIG. 3, the moderator structure 128 may be or include a generally cylindrical structure with opposing contoured edges, all of which may be nested in the channelizing assembly 160, as described herein. For example, the moderator structure 128 may include a reactor core top side 133 and a reactor core bottom side 132 that is opposite the top side 133. The reactor core top side 133 may include top side contoured edges 133a, 133b. The reactor core bottom side 132 may include bottom side contoured edges 132a, 132b. As described in greater detail herein, for example at FIGS. 5A and 5B, the channelizing assembly 160 may be configured to nest and contour generally to the respective contoured edges 132a, 132b, 133a, 133b of the moderator structure 128. The moderator structure 128 may permit the flow of a fuel salt therethrough. For example, the moderator structure 128 may receive fuel salt and influence the rate of fission reactions that occur in the fuel salt that passes therethrough. In this regard, the moderator structure 128 of FIG. 3 shows a representative passage 134 that generally extends between a flow entrance 140a at the reactor core bottom side 132 and a flow exit 140b at the reactor core top side 133. It will be appreciated that the reactor core passage 134 is shown for purposes of illustration; in other cases, the moderator structure 128 may include numerous ones of such passages to facilitate the flow of fuel salt therethrough. Additionally, fuel salt may flow relative to the moderator structure 128 along a moderator periphery 136a, 136b. As further described herein, the channelizing assembly 160 may also be configured to nest, and be contoured relative to, the moderator periphery 136a, 136b. In this regard, peripheral flow zones 141a, 141b may be established between the respective moderator periphery 136a, 136b and the adjacent channelizing assembly 160 such the fuel salt may flow therethrough in addition to flowing through any of the passages (e.g., the representative passage 134) of the moderator structure 128.

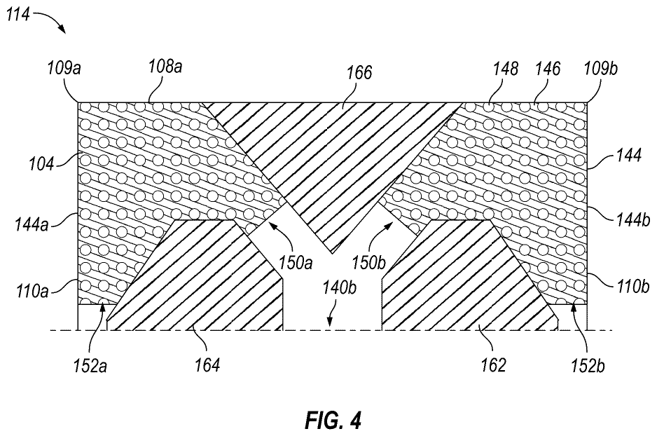

With reference to FIG. 4, the heat exchange section 114 is described in greater detail below. The heat exchanger section 114 is shown as including the heat exchanger assembly 144, as described herein. For example, the heat exchange assembly 144 may include at least a first heat exchanger 144a disposed in a first corner 109a of the reactor vessel 104, and a second heat exchanger 144b disposed in a second corner 109b of the reactor vessel 104. It will be appreciated that the cross-sectional view of FIG. 4 is shown for purposes of illustration; in some cases, the first and second heat exchangers 144a, 144b may be components of the same, continuous heat exchanger. The heat exchanger assembly 144 may be any appropriate type of heat exchanger that is configured to transfer heat from a fuel salt of the reactor vessel 104 to another medium, such as a coolant salt. For purposes of illustration, the heat exchanger assembly 144 is shown as a shell and tube type heat exchanger including a representative shell 146 and tubes 148. Broadly, fuel salt of the reactor vessel 104 may propagate from the reactor core 124 to the heat exchanger assembly 144 via the flow exit 140b. For example, the flow exit 140b may generally be defined by at least the channelizing structure 162, 164 shown in FIG. 4. From the flow exit 140b the fuel salt may proceed to the heat exchanger assembly 144 via one of the heat exchanger entrances 150a, 150b. The heat exchanger entrances 150a, 150b may be defined, in part, by the flow structure 166 which may operate to divert the flow of the fuel salt as between the first and second heat exchangers 144a, 144b (e.g., for flowing of the fuel salt generally toward the first and second corners 109a, 109b of the reactor vessel 104). In this regard, the flow exit 140b and the heat exchanger entrances 150a, 150b may, collectively, define a dedicated channel between the reactor core 124 and the heat exchanger assembly 144. Such dedicated channel between the reactor core 124 and the heat exchanger assembly 144 may define a hot leg through which an elevated-temperature flow of the molten salt may flow, fluidically separated from a reduced-temperature flow of salt that is output from the heat exchanger assembly 144. For example, FIG. 4 further shows heat exchanger exits 152a, 152b that may be defined by a portion of the channelizing structures 162, 164 and the peripheral walls 110a, 110b of the reactor vessel 104. At the heat exchanger exits 152a, 152b, the heat exchanger assembly 144 may output a reduced-temperature flow of the fuel salt (e.g., after removing heat therefrom and transfer said heat to a coolant medium of the heat exchanger assembly 144). The heat exchanger exits 152a, 152b and associated flow paths therefrom may define one or more dedicated channel between the heat exchanger assembly 144 and the reactor core 124. Such dedicated channels between the heat exchanger assembly 144 and the reactor core 124 may define a cold leg through which a reduced-temperature flow of the molten salt may flow, fluidically separated from the elevated-temperature flow of the salt that is introduced into the respective heat exchangers 144a, 144b.

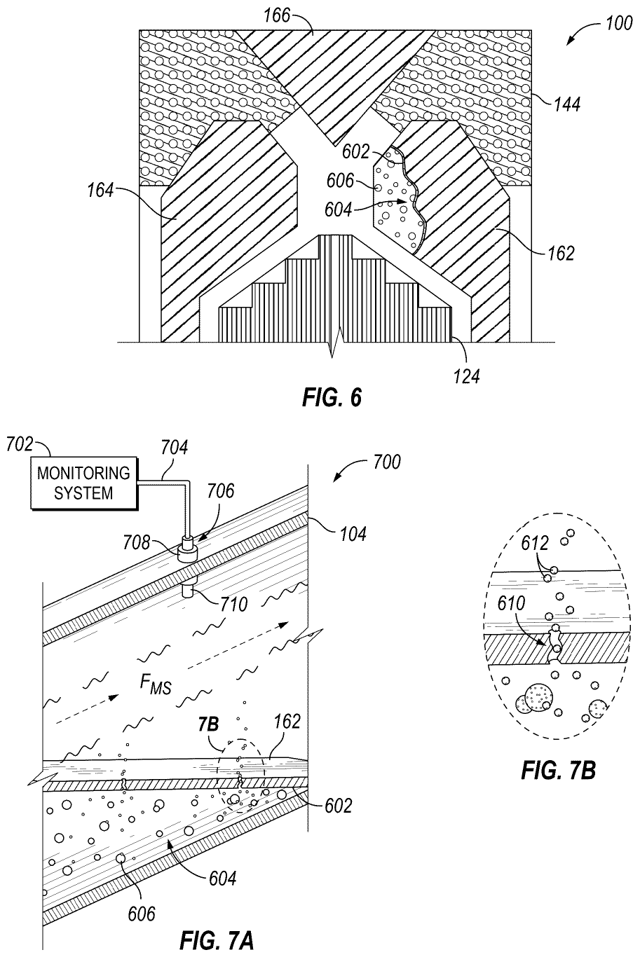

With reference to FIGS. 5A and 5B, the channelizing assembly 160 is described in greater detail below. For example, FIG. 5A shows various channelizing structures of the channelizing assembly 160, including the inner insert pieces 162, 164, hot leg diverter 166, cold leg flow guides 170, 172, and cold leg combinator insert 168 described herein. One or more or all of such channelizing structures may include or be formed as a hollow metal shell having a void space contained therein (e.g., for the inclusion of an inert gas within said void space), as shown in greater detail with reference to FIG. 6. The channelizing assembly 160 and structures contained therein may cooperate to nest the moderator structure 128 and define various dedicated flow channels or paths therethrough, as described in greater detail with respect to FIG. 5B. In this regard, it will be appreciated that the channelizing structures may be constructed with any appropriate shape in order to function to displace a given volume of molten salt from the integral MSR 100 and to define the dedicated channels described herein. For purposes of illustration, FIG. 5A shows the inner insert piece 162 as including sides 162a, 162b, 162c, 162d, 162e, 162f, 162g, 162h, 162i, 162j, 162k. Further, FIG. 5A shows the inner insert piece 164 as including sides 164a, 164b, 164c, 164d, 164e, 164f, 164g, 164h, 164i, 164j, 164k. It will be appreciated that the inner insert piece 162 and the inner insert piece 164 may be components of the same structure that is revolved about the longitudinal axis 102. In other cases, the inner insert piece 162 and the inner insert piece 164 may be complementary pieces that collectively form a continuous structure about the longitudinal axis 102 of the reactor vessel 104.

With continued reference to FIG. 5A, the channelizing assembly 160 is shown with the hot leg diverter 166 including sides 166a, 166b, 166c. The channelizing assembly 160 is further shown with the cold leg combinator insert 168 as including sides 168a, 168b, 168c. The channelizing assembly 160 is further shown with the cold leg flow guide 170 as including sides 170a, 170b, 170c. The channelizing assembly 160 is further shown with the cold leg flow guide 172 as includes sides 172a, 172b, 172c.

With reference to FIG. 5B, the channelizing assembly 160 is shown with reference to the various dedicated channels defined by the channelizing structures. For example, the first and second inner inserts 162, 164 may cooperate to define a channel 174. The channel 174 may be configured to house the reactor core 124 and to route fuel salt along a flow path F1 therethrough. The first and second inner inserts 162, 164 may further cooperate to define a channel 175. The channel 175 may be a dedicated channel for flow of an elevated-temperature fuel salt from the reactor core 124 along a flow path F₂. The flow path F₂ may be diverted by the hot leg diverter 166. For example, the flow path F₂ may encounter the hot leg diverter 166 and split substantially into a flow path F₃ and a flow path F₁₃. For example, the hot leg diverter 166 and the inner insert 164 may cooperate to define a channel 176a for flow of the flow path F₃ therethrough. Further, the hot leg diverter 166 and the inner insert 162 may cooperate to define a channel 176b for flow of the flow path F₁₃ therethrough. The channels 175, 176a, 176b may, collectively define a dedicated channel between the reactor core 124 and the heat exchanger assembly. Such dedicated channel may be fluidically separated from the reactor cold leg, as described herein.

For example, the reactor cold leg may be defined, collectively, by channels 177a, 178a, 179a, 180a, which are defined by the inner insert 164 and the reactor vessel 104 and/or cold leg flow guide 170, as shown in FIG. 5B. For example, on exit from a heat exchanger, the channels 177a, 178a, 179a, 180a may each be configured to route a flow of a reduced-temperature fuel salt along a flow path F₄, F₅, F₆, F₇, respectively. The cold leg flow paths F₄, F₅, F₆, F₇, may, collectively, define one or more dedicated channels between the heat exchanger assembly 144 and the reactor core 124, and which are fluidically separated from the dedicated channels that define the hot leg. The cold leg may be further defined, collectively, by channels 177b, 178b, 179b, 180b, which are defined by the inner insert 162 and the reactor vessel 104 and/or the cold leg flow guide 172, as further shown in FIG. 5B. For example, on exit from a heat exchanger, the channels 177b, 178b, 179b, 180b may each be configured to route a flow of a reduced-temperature fuel salt along a flow path F₁₄, F₁₅, F₁₆, F₁₇, respectively. The cold leg flow paths F₁₄, F₁₅, F₁₆, F₁₇, may, collectively, define one or more dedicated channels between the heat exchanger assembly and the reactor core, and which are fluidically separated from the dedicated channels that define the hot leg. Finally, as shown in FIG. 5B, the cold leg combinator insert 168 may be configured to combine one or more flows of the cold legs for reintroduction into the reactor core. For example, the cold leg combinator insert 168 may combine a cold leg flow F₈ and a cold leg flow F₁₈ into a channel 181 for reintroduction of the flow into the reactor core, for example, for combination into the flow F1, described herein. In this regard, the channelized assembly 160 may collectively operate to channel and route the flow of molten salt between the reactor core and the heat exchanger, fluidically isolating the hot and cold legs therebetween to support the thermal efficiency of the system 100.

FIG. 6 depicts a cutaway view of the channelizing assembly 160 of FIG. 1 including an inert gas therein. For example, FIG. 6 shows the integral MSR 100 as including a cutaway view of the channelizing structure 162. The channelizing structure 162 may be formed from a metal material 602. The metal material 602 may be a metal material that is configured to withstand molten salt service. The metal material 602 may define a void space 604 therein. The void space 604 may be filled with an inert gas 606. An example inert gas 606 is helium; although in other cases, other gas may be used. It will be appreciated that each of the channelizing structures of the channelizing assembly 160 may be constructed from metal shell that defines a hollow void, similar to that shown in relation to the channelizing structure 162 of FIG. 6. For example, each of the inner insert pieces 162, 164, hot leg diverter 166, cold leg flow guides 170, 172, and cold leg combinator insert 168 may be formed from a metal shell that defines such hollow void. The volume of all the channelizing structures, regardless of whether such structure is hollow, may collectively define a displacement volume. The displacement volume may be configured to minimize a volume of the fuel salt required for operation of the integral MSR 100.

Turning to FIGS. 7A and 7B, a flow segment 700 of the integral MSR 100 is shown. The flow segment 700 shows a flow of molten salt Fₘₛ through the reactor vessel 104 adjacent the channelizing structure 162 described above in relation to FIG. 6. With reference to FIG. 7A, the inert gas 606 is shown within the void space 604 and separated from the flow of molten salt Fₘₛ by the metal material 602. With reference to FIG. 7B, over time, microcracks 610 may develop in the metal material 602. The microcracks 610 may result from the operative effects of corrosion of the metal material 602 as may be caused by the molten fuel salt of the present disclosure. For example, FIG. 7B shows released inert gas 612 progressing through the microcracks 610 and substantially into the flow of molten salt Fₘₛ.

With continued reference to FIGS. 7A and 7B, the channelizing structure 162 may be used in connection with a monitoring system 702 to determine one or more corrosive parameters or properties of the reactor vessel 104. For example, the metal material 602 may be the same or comparable metal material as that used to construct the reactor vessel 104. In this regard, as the metal material 602 corrodes, information associated with a corrosive state of the metal material 602 may be used to determine said one or more corrosive parameters or properties of the reactor vessel 104. To illustrate, consider that as the metal material corrodes it may permit the released inert gas 612 to dissolve into or otherwise combine with the molten salt of the system 100. In some cases, the released gas 612 may be detected within the molten salt stream and used to determine the corrosive state of the system 100. For example, the flow segment 700 is shown in FIG. 7A as including the monitoring system 702. The monitoring system 702 may be a computer-implemented device, such as that described in relation to FIG. 12, herein. The monitoring system 702 may be operatively connected to the flow segment 700 in order to detect a level of the released inert gas 612 within the molten salt flow. To facilitate the foregoing, the monitoring system 702 is shown operatively coupled with an electrical coupling 704. The electrical coupling is attached to a sensor assembly 706. The sensor assembly 706 may include an outer fixture 708 and an inner fixture 710. The outer fixture 708 may be coupled to an exterior of the reactor vessel 104. The inner fixture 710 may be coupled to an interior of the reactor vessel 104 and may include one or more sensing probes. The one or more sensing probes may be any appropriate component to detect a level (or a change or an increase) of the released insert gas 612 in the system 100, such as that which may be caused from a release of such gas from the microcracks 610. On detection of said level of the released insert gas 612 within the fuel salt, the monitoring system 702 may operate to deliver an indication that the level exceeds a threshold. For example, the indication may be associated with a leak of the inert gas from the pressurized void space of the hollow metal shell of the channelizing structure 162. In some cases, the monitoring system 702 may further be configured to determine one or more parameters indicative of a corrosivity of the integral molten salt reactor based in part by the indication of the leak. For example, a measured quantity of the released insert gas 612 within the system 100 may be associated with a calculated corrosivity rate that caused the microcracks 610 in the metal structure 610. Said calculated corrosivity rate may be correlated to a likely corrosive state of the reactor vessel 104. In this regard, the channelizing structure 162 may be used, in conjunction with the monitoring system 702, to provide a potential early warning concerning the corrosive state of the system 100.

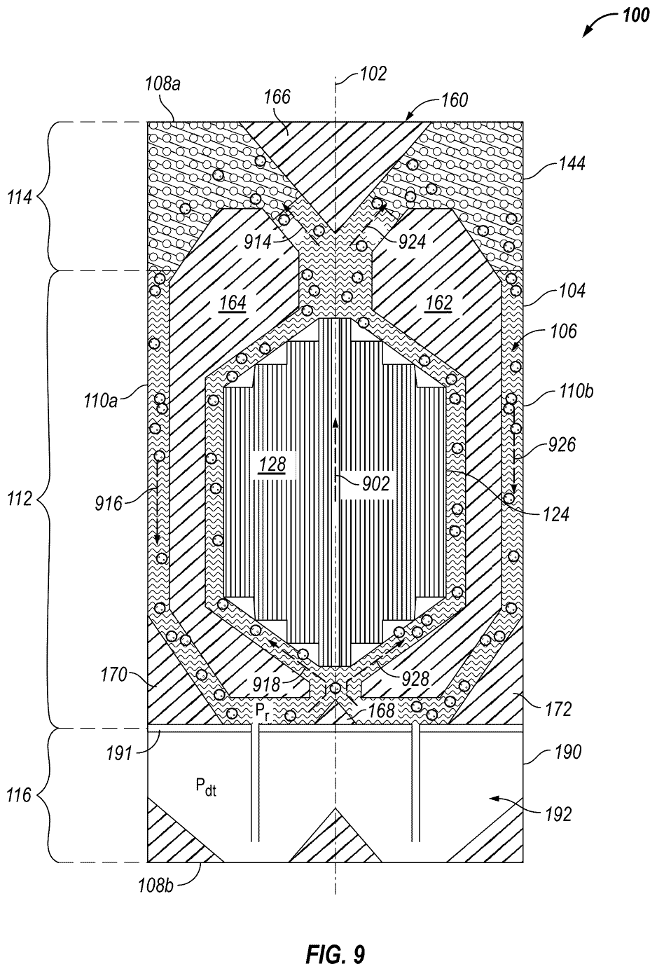

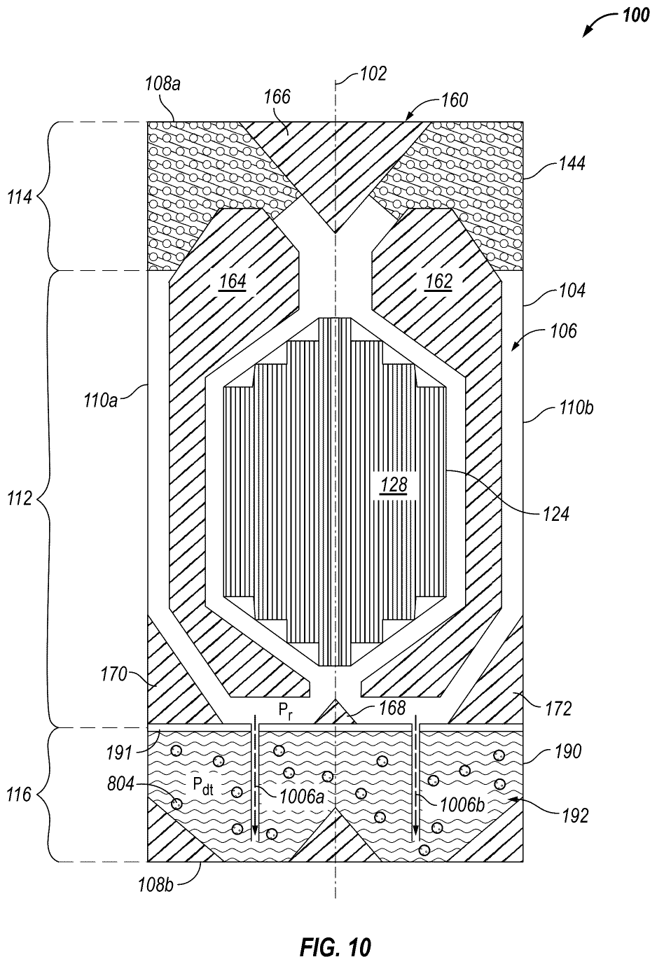

With reference to FIGS. 8-10, the integral MSR 100 is shown according to different configurations or methods of operation. For example, FIG. 8 depicts the example integral molten salt reactor of FIG. 1 in a first configuration; FIG. 9 depicts the example integral molten salt reactor of FIG. 1 in a second configuration; and FIG. 10 depicts the example integral molten salt reactor of FIG. 1 in a third configuration. For example, with reference to FIG. 8, the integral MSR 100 is shown in a first configuration in which the fuel salt 804 is held within the drain tank 190. The first configuration shown in FIG. 8 may be a shut-down or non-critical state of the integral MSR 100. In such non-critical state, the fuel salt 804 is held away from the reactor core 124 within the drain tank 190. For example, the structural barrier 191 may physically separate the reactor core 124 from the fuel salt 804 held within the drain tank 190. Further shown in FIG. 8, the fuel salt 804 may not circulate in such shut-down configuration. The fuel salt 804 may instead remain in the drank tank 190 due in part to the pressure P_{dt} being less than the pressure Pᵣ. In preparation for transitioning out of the first configuration, a pressure differential may be induced (e.g., by an inert gas system, not depicted for clarity with reference to FIGS. 8-10) whereby P_{dt} becomes greater than the pressure Pᵣ. This change in pressure may cause transitional flows 806a, 806b of the fuel salt to propagate through the transfer pipes 193a, 193b such that the fuel salt may begin to flow out of the drain tank 190 and toward the reactor core 124.

With reference to FIG. 9, a second configuration of the integral MSR 100 is shown in an operational state whereby the fuel salt 804 is circulated through the system 100. For example, subsequent to the first configuration shown in FIG. 9, the pressure differential between P_{dt} and Pᵣ may be such to cause all or substantially all of the fuel salt 804 to exit the drain tank 190 and to enter the reactor vessel 104 and bathe the reactor core 104 therein. In this regard, the fuel salt is shown in FIG. 9 in a configuration in which the salt circulates through the reactor section 112 and the heat exchanger section 114. The fuel salt 804 may substantially fill such space and bathe the reactor core 124 therein. As shown in FIG. 9, the fuel salt 804 may proceed generally through the reactor core 124 (e.g., though passages in a moderator material 128 of the reactor core) along a reactor flow 902. The fuel salt 804 may undergo fission reactions along the reactor flow 902, for example, the cause the fuel salt 804 to increase in temperature to establish an elevated-temperature flow of the fuel salt 804. Further, the fuels salt 804 may exit the reactor core 124 and proceed along one of the hot leg flows 914, 924. The hot leg flows 914, 924 may be dedicated flow paths between the reactor core 124 and the heat exchanger assembly 144 that are collectively defined by the channelizing assembly 160, as described herein. As further shown in FIG. 9, the hot leg flows 914, 924 may enter the heat exchanger assembly 144. The heat exchanger assembly 144 may cause heat from the fuel salt to transfer to a coolant medium (e.g., a coolant salt). Accordingly, the heat exchanger assembly 144 may output a reduced-temperature flow of fuel salt 804 along cold leg flows 916, 918 and/or cold leg flows 926, 928. As described herein, such cold leg flows 916, 918, 926, 928 may be dedicated flow paths between the heat exchanger assembly 144 and the reactor core 124 that are collectively defined by the channelizing assembly 160, as described herein. The cold leg flows 926, 928 may be routed back into the reactor core 924, and into the reactor flow 902, for recirculation of the fuel salt 804.

The fuel salt 804 may circulate within the reactor vessel 104 as shown in the second configuration of FIG. 9 based in part on natural convection. For example, the fuel salt 804 may be heated within the reactor core 124, thereby causing said fuel salt 804 to rise within the reactor core 124. Conversely, the fuel salt 804 may be relatively cooler on exit from the heat exchanger assembly 114, thereby causing said fuel salt 804 to fall along the periphery of the reactor vessel 104 for subsequent recirculation of the fuel salt into the reactor core 124. Additionally or alternatively, a mechanical pump may be used to encourage circulation of the fuel salt 804 in the manner described in FIG. 9. The fuel salt 804 may be maintained in circulation with the reactor section 112 and the heat exchange section 114 as supported by the P_{dt} being continually greater than the pressure Pᵣ. The fuel salt 804 may therefore be capable of draining to the drain tank 190 upon such pressure differential changing, as described in relation to FIG. 10.

With reference to FIG. 10, a third configuration of the integral MSR 100 is shown in which the fuel salt 804 has returned to the drain tank 190. For example, subsequent to the operational state shown with reference to FIG. 9, it may be desirable to transition the fuel salt 804 out of the reactor section 112 and the heat exchanger section 114 in a rapid manner. For example, it may be desirable to move the fuel salt 804 away from such components in order to cool the fuel salt 804 and transition the fuel salt 804 to a subcritical state. In this regard, a pressure differential may be induced whereby the pressure P_{dt} is changed to be less than the pressure Pᵣ. Upon inducing such pressure differential change, the fuel salt 804 may flow gravitationally into the drain tank 190. For example, the fuel salt 804 may flow through the transfer pips 193a, 193b along respective transitional flows 1006a, 1006b. The fuel salt 804 may remain in the drain tank 190 until it is desired to enter the operational state of the integral MSR 100. At which point, the fuel salt 804 may be reintroduced into the reactor section 112 and the heat exchanger section 114 and recirculated therein substantially as described in relation to FIGS. 8 and 9.

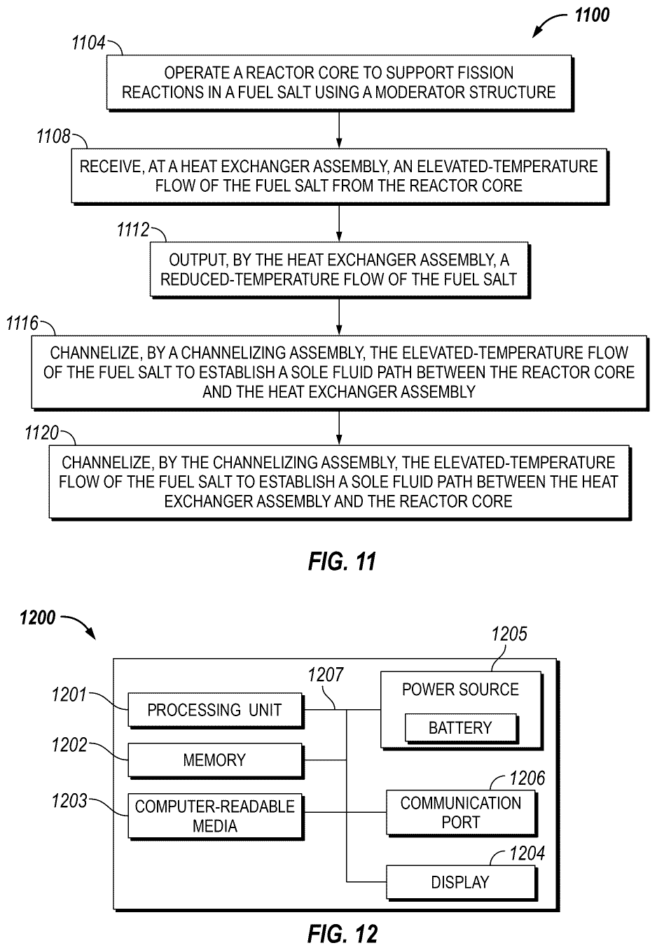

FIG. 11 depicts a flow diagram of a method 1100 of operating an internal molten salt reactor. At operation 1104, a reactor core is operated within a reactor vessel. The reactor core is operated to support fission reactions in a fuel salt using a moderator structure and to thereby cause a heating of the fuel salt through said fission reactions. For example, and with reference to FIGS. 1 and 9, the reactor core 124 is operated within the reactor vessel 104. The reactor core 124 is operated to support fission reactions in the fuel salt 804 using the moderator structure 128. Such operation may cause a heating of the fuel salt 804 through said fission reactions. At operation 1108, a heat exchanger assembly arranged within the reactor vessel receives an elevated-temperature flow of the fuel salt from the reactor core along a reactor hot leg. For example, and with continued reference to FIGS. 1 and 9, the heat exchanger assembly 114 is arranged with the reactor vessel 104. The heat exchanger assembly 144 receives an elevated-temperature flow of the fuel salt along a reactor hot leg (e.g., along the hot leg flows 914, 924).

At operation 1112, the heat exchanger assembly outputs a reduced-temperature flow of the fuel salt along a reactor cold leg. For example, and with continued reference to FIGS. 1 and 9, the heat exchanger assembly 144 outputs a reduced-temperature flow of the fuel salt 804 along a reactor cold leg (e.g., along the cold leg flows 916, 918, 926, 928). At operation 1116, the elevated-temperature flow of the fuel salt is channelized, using a channelizing assembly that nests the moderator structure therein and that fluidically separates the reactor hot leg and the reactor cold leg from one another, to establish a sole fluid path of the reactor hot leg between the reactor core and the heat exchanger assembly. For example, and with reference to FIGS. 1, 5A, 5B and 9, the channelizing assembly 160 may be contoured and configured to nest the moderator structure 128 therein. The channelizing structures (e.g., the inner insert pieces 162, 164, hot leg diverter 166, cold leg flow guides 170, 172, and cold leg combinator insert 168) of the channelizing assembly 160 may cooperate to define dedicated flow paths (e.g., the flow paths F₂, F₃, F₁₃) between the reactor core 124 and the heat exchanger assembly 144. At operation 1120, the reduced-temperature flow of the fuel salt is channelized, using the channelizing assembly, to establish a sole fluid path of the reactor cold leg between the heat exchanger assembly and the reactor core. For example, and with reference to 1, 5A, 5B and 9, the channelizing structures (e.g., the inner insert pieces 162, 164, hot leg diverter 166, cold leg flow guides 170, 172, and cold leg combinator insert 168) of the channelizing assembly 160 may cooperate to define dedicated flow paths (e.g., the flow paths F₅, F₆, F₇, F₈, F₁₅, F₁₆, F₁₇, F₁₀) between the heat exchanger assembly 144 and the reactor core 124.

FIG. 12 depicts a functional block diagram of a computing system 1200. The schematic representation in FIG. 12 is generally representative of any types of systems and configurations that may be used to receive and process the various signals from the sensors and monitoring systems described herein. For example, the computing system 1200 may be used to control or compute one or more functions described herein with respect to the monitoring system 702, and to perform any of the associated functions described herein. In this regard, the computing system 1200 may include any appropriate hardware (e.g., computing devices, data centers, switches), software (e.g., applications, system programs, engines), network components (e.g., communication paths, interfaces, routers) and the like (not necessarily shown in the interest of clarity) for use in facilitating any appropriate operations disclosed herein.

As shown in FIG. 12, the computing system 1200 may include a processing unit or element 1201 operatively connected to computer memory 1202 and computer-readable media 1203. The processing unit 1201 may be operatively connected to the memory 1202 and computer-readable media 1203 components via an electronic bus or bridge (e.g., such as system bus 1207). The processing unit 1201 may include one or more computer processors or microcontrollers that are configured to perform operations in response to computer-readable instructions. The processing element 1201 may be a central processing unit of the computing system 1200. Additionally or alternatively, the processing unit 1201 may be other processors within the device including application specific integrated chips (ASIC) and other microcontroller devices.

The memory 1202 may include a variety of types of non-transitory computer-readable storage media, including, for example, read access memory (RAM), read-only memory (ROM), erasable programmable memory (e.g., EPROM and EEPROM), or flash memory. The memory 1202 is configured to store computer-readable instructions, sensor values, and other persistent software elements. Computer-readable media 1203 may also include a variety of types of non-transitory computer-readable storage media including, for example, a hard-drive storage device, a solid state storage device, a portable magnetic storage device, or other similar device. The computer-readable media 1203 may also be configured to store computer-readable instructions, sensor values, and other persistent software elements.

In this example, the processing unit 1201 is operable to read computer-readable instructions stored on the memory 1202 and/or computer-readable media 1203. The computer-readable instructions may adapt the processing unit 1201 to perform the operations or functions described above with respect to FIGS. 1-11. The computer-readable instructions may be provided as a computer-program product, software application, or the like.

As shown in FIG. 12, the computing system 1200 may also include a display 1204. The display 1204 may include a liquid-crystal display (LCD), organic light emitting diode (OLED) display, light emitting diode (LED) display, or the like. If the display 1204 is an LCD, the display may also include a backlight component that can be controlled to provide variable levels of display brightness. If the display 1204 is an OLED or LED type display, the brightness of the display 1204 may be controlled by modifying the electrical signals that are provided to display elements.

The computing system 1200 may also include a battery that is configured to provide electrical power to the components of computing system 1200. The battery may include one or more power storage cells that are linked together to provide an internal supply of electrical power. In this regard, the battery may be a component of a power source 1205 (e.g., including a charging system or other circuitry that supplies electrical power to components of the computing system 1200). The battery may be operatively coupled to power management circuitry that is configured to provide appropriate voltage and power levels for individual components or groups of components within the computing system 1200. The battery, via power management circuitry, may be configured to receive power from an external source, such as an AC power outlet or interconnected computing device. The battery may store received power so that the computing system 1200 may operate without connection to an external power source for an extended period of time, which may range from several hours to several days.

The computing system 1200 may also include a communication port 1206 that is configured to transmit and/or receive signals or electrical communication from an external or separate device. For example, in the present disclosure, the computing system 1200 in the monitoring system 702 is configured to transmit and/or receive signals or electrical communication from a sensing device 706, among other sensors. The communication port 1206 may be configured to couple to an external device via a cable, adaptor, or other type of electrical connector. In some embodiments, the communication port 1206 may be used to couple the computing system 1200 with a computing device and/or other appropriate accessories configured to send and/or receive electrical signals. The communication port 1206 may be configured to receive identifying information from an external accessory, which may be used to determine a mounting or support configuration. For example, the communication port 1206 may be used to determine that the computing system 1200 is coupled to a mounting accessory, such as a particular type of stand or support structure.

Other examples and implementations are within the scope and spirit of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. An integral molten salt reactor comprising
a reactor vessel including a fuel salt;
a reactor core arranged with the reactor vessel and including a moderator structure, wherein the reactor core is configured to support fission reactions in the fuel salt using the moderator structure, and to cause a heating of the fuel salt through said fission reactions;
a heat exchanger assembly arranged within the reactor vessel and configured to receive an elevated-temperature flow of the fuel salt from the reactor core along a reactor hot leg, and to output a reduced-temperature flow of the fuel salt therefrom along a reactor cold leg; and
a channelizing assembly arranged within the reactor vessel and including a plurality of channelizing structures cooperating to nest the moderator structure within the channelizing assembly and define one or more dedicated channels between with the reactor core and the heat exchanger assembly that fluidically separates the reactor hot leg and the reactor cold from one another.

2. The integral molten salt reactor of claim 1, wherein the plurality of channelizing structures defines a displacement volume configured to minimize a volume of the fuel salt required for operation of the integral molten salt reactor.

3. The integral molten salt reactor of claim 1, wherein at least one channelizing structure of the plurality of channelizing structures comprises a hollow metal shell defining a void space therein.

4. The integral molten salt reactor of claim 3, wherein the void space is filled and pressurized with an inert gas.

5. The integral molten salt reactor of claim 4, further comprising a monitoring system integrated with reactor vessel and configured to
detect a level of the inert gas within the fuel salt, and
deliver an indication that the level exceeds a threshold associated with a leak of the inert gas from the pressurized void space of the hollow metal shell.

6. The integral molten salt reactor of claim 5, wherein the monitoring system is further configured to determine one or more parameters indicative of a corrosivity of the integral molten salt reactor based in part on the indication of the leak.

7. The integral molten salt reactor of claim 1, wherein the one or more dedicated channels defines a hot leg passage that is a sole fluid path of the reactor hot leg between the reactor core and the heat exchanger assembly.

8. The integral molten salt reactor of claim 7, wherein the hot leg passage diverts the elevated-temperature fuel salt between heat exchangers of the heat exchanger assembly disposed in upper corners of the reactor vessel.

9. The integral molten salt reactor of claim 7, wherein the one or more dedicated channels further defines cold leg passages that collectively form a sole fluid path of the reactor cold leg between the heat exchanger assembly and the reactor core.

10. The integral molten salt reactor of claim 9, wherein the cold leg passages route the reactor cold leg about a periphery of the reactor vessel and concentric about the reactor core.

11. The integral molten salt reactor of claim 10, wherein the one or more dedicated channels further defines a cold leg passage that combines the reduced-temperature fuel salt of all of the cold leg passages and is the sole fluid path of the reactor cold leg into the reactor core.

12. A method of operating an integral molten salt reactor, the method comprising
operating a reactor core, within a reactor vessel, to support fission reactions in a fuel salt using a moderator structure and thereby causing a heating of the fuel salt through said fission reactions;
receiving, at a heat exchanger assembly arranged within the reactor vessel, an elevated-temperature flow of the fuel salt from the reactor core along a reactor hot leg;
outputting, by the heat exchanger, a reduced-temperature flow of the fuel salt along a reactor cold leg; and
channelizing, using a channelizing assembly that nests the moderator structure therein and that fluidically separates the reactor hot leg and the reactor cold leg from one another,
the elevated-temperature flow of the fuel salt to establish a sole fluid path of the reactor hot leg between the reactor core and the heat exchanger assembly, and
the reduced-temperature flow of the fuel salt to establish a sole fluid path of the reactor cold leg between the heat exchanger assembly and the reactor core.

13. The method of claim 12, wherein the channelizing further comprises, using the channelizing assembly, to
establish the sole fluid path of the reactor hot leg as along a longitudinal centerline of the reactor vessel, and
establish the sole fluid path of the reactor cold leg as collectively, peripherally about the longitudinal centerline of the reactor vessel.

14. The method of claim 12, wherein
the channelizing assembly comprises a plurality of channelizing structures including at least one channelizing structure, the at least one channelizing structure comprises a hollow metal shell defining a void space therein, and
the method further comprises maintaining a pressurized inert gas within the void space.

15. The method of claim 14, wherein
the reactor vessel is integrated with a monitoring system, and
the method further comprises, using the monitoring system,
detecting a level of the inert gas within the fuel salt, and
delivering an indication that the level exceeds a threshold associated with a leak of the inert gas from the pressurized void space of the hollow metal shell.

16. The method of claim 15, further comprising, using the monitoring system, determining one or more parameters indicative of a corrosivity of the integral molten salt reactor based in part on the indication of the leak.

17. An integral molten salt reactor comprising
a reactor vessel including a fuel salt;
a reactor core arranged with the reactor vessel and including a moderator structure, wherein the reactor core is configured to support fission reactions in the fuel salt using the moderator structure and to cause a heating of the fuel salt through said fission reactions;
a heat exchanger assembly arranged within the reactor vessel and configured to receive an elevated-temperature flow of the fuel salt from the reactor core along a reactor hot leg and to output a reduced-temperature flow of the fuel salt therefrom along a reactor cold leg; and
a channelizing assembly arranged within the reactor vessel and including a plurality of channelizing structures cooperating to nest the moderator structure within the channeling assembly, and to establish
a sole fluid path of the reactor hot leg as along a longitudinal centerline of the reactor vessel, and
a sole fluid path of the reactor cold leg as collectively peripherally about the longitudinal centerline of the reactor vessel.

18. The integral molten salt reactor of claim 17, wherein the plurality of channelizing structures defines a displacement volume configured to minimize a volume of the fuel salt required for operation of the integral molten salt reactor.

19. The integral molten salt reactor of claim 17, wherein at least one channelizing structure of the plurality of channelizing structures comprises a hollow metal shell defining a void space therein.

20. The integral molten salt reactor of claim 17, wherein the void space is filled and pressurized with an inert gas.
